(19) United States
(12) Patent Application Publication
(10) Pub. No.: US 2001/0034836 A1
(43) Pub. Date: Oct. 25, 2001

(54) System for secure certification of network

(75) Inventors: Kazufumi Matsumoto, Tokyo (JP); Mitsuhiro Yosikawa, Tokyo (JP)

Correspondence Address: MCDERMOTT WILL & EMERY, 600 13TH STREET, N.W., WASHINGTON, DC, 20005-3096, US

(73) Assignee: Netmarks Inc.

(21) Appl. No.: 09/771,895

(22) Filed: Jan. 30, 2001

Related U.S. Application Data
(60) Provisional application No. 60/179,010, filed on Jan. 31, 2000.

(51) Int. Cl. H04L 9/00

(52) U.S. Cl. 713/176; 713/156

(57) ABSTRACT

An authentication system 10 of this invention includes an authentication station 20 having a directory server 24 and a biometrics collation server 30 capable of collating biometrics data based on the biological features of a user, and a user terminal 60 connected to the authentication station 20 via a network 12. The biometrics data is transmitted from the user terminal 60. In the authentication station 20, the biometrics collation server 30 collates biometrics data transmitted from a user with biometrics data registered in advance. The authentication station 20 can check validity of a digital certificate 66 by the directory server 24 and collates the biometrics data, thereby allowing personal authentication.

### BACKGROUND OF THE INVENTION

1 . Field of the Invention

The present invention relates to an authentication station for authenticating a communication partner connected to a network, an authentication system having the authentication station, and an authentication method.

2. Related Background Art

Along with the developments of services using the Internet, it has recently been important to authenticate communication partners in various occasions such as use of resources on the Internet and contracts through mail. As a conventional authentication system, an authentication system using a so-called PKI (Public Key Infrastructure) is widely used.

The above authentication system has the following mechanism. A person who wants to be authenticated (to be referred to as a “user” hereinafter) transmits a text not subjected to predetermined encryption (to be referred to as a “plaintext” hereinafter) and a cipher text obtained by encrypting the plaintext with his own private key to a partner who authenticates the user (to be referred to as an “authenticator” hereinafter). The authenticator who has received the plaintext and cipher text decrypts the cipher text with the user's public key authenticated by the authentication station. The authenticator then collates the decrypted text with the plaintext to authenticate the user. A person who can prepare a cipher text is a user having a private key paired with the public key (for this reason, this cipher text is called as a “digital signature”). As a result of collation, when the transmitted plaintext coincides with the decrypted text, the user can be authenticated.

### SUMMARY OF THE INVENTION

In the above authentication system, however, the authenticator cannot authenticate a specific person in a strict sense, although the authenticator can authenticate a person having a private key. More specifically, even if a malicious third party who has stolen a private key behaves like an authentic user, the authenticator cannot discriminate the malicious third party from the authentic user. In addition, the authenticator cannot identify a third party who borrows the private key from an authentic user and sets up for the authentic user. The third party who borrows the private key can enjoy services that are supposed to be offered to only the authentic user who paid, e.g., predetermined fees.

It is an object of the present invention to solve the conventional problem described above and provide an authentic station capable of performing highly reliable personal authentication in authentication on a network, an authentication system using the authentication station, and an authentication method.

An authentication station for authenticating a user connected to a network is characterized by comprising digital certificate storage means for storing a digital certificate issued to the user and validity data representing validity of the digital certificate, registration data storage means for storing as registration data biometrics data based on a biological feature of the user, a collation server for collating biometrics data transmitted from the user with the registration data stored in the registration data storage means, and authentication means for determining the validity of the digital certificate of the user, for which authentication is demanded, on the basis of the validity data stored in the digital certificate storage means, and authenticating the user on the basis of a result of the validity determination and a collation result of the collation server.

The authentication station according to the present invention comprises the digital certificate storage means for storing a digital certificate issued to the user and validity data representing validity of the digital certificate, and the registration data storage means for storing as registration data biometrics data based on a biological feature of the user. The collation means collates the registration data stored in the registration data storage means with the biometrics data transmitted from the user. On the basis of the validity data stored in the digital certificate storage means, the authentication means determines validity for whether the valid dates of the digital certificate expire or the digital certificate is invalidated and performs authentication together with the collation result from the collation means. As described above, in addition to the validity determination of the digital certificate, the biological feature of the user is also collated to perform authentication. Therefore, the third party who sets up for the authentic user can be discriminated, and highly reliable personal authentication can be performed.

The above authentication station may be characterized in that the collating means collates a plurality of kinds of biometrics data. The biometrics data include behavior attributes, which do not change for a long period of time, such as a fingerprint, face, retina, iris, palm print, voiceprint, and the like as the biological features. Various other biological features are available. According to the present invention, the collation means collates a plurality of kinds of biometrics data to flexibly cope with various user's needs.

The authentication station may be characterized in that the digital certificate storage means stores valid dates of the registration data stored in the registration data storage means, and the authentication means determines the validity of the biometrics data of the user, for which authentication is demanded, on the basis of the valid dates stored in the digital certificate storage means. The biometrics data represent human biological features changing over time. Therefore, even if a user stores his own biometrics data in the registration data storage means, proper collation may not be performed. This can be prevented by storing the valid dates of the biometrics data.

The above authentication station may be characterized by further comprising an issuing station for issuing the digital certificate, the issuing station being adapted to store the valid dates of the biometrics data in the digital certificate storage means when issuing the digital certificate. When the issuing station for issuing the digital certificate is arranged, the valid dates of the biometrics data can be stored together with the digital certificate.

The above authentication station is preferably characterized by further comprising amount storage means for storing an authentication compensation amount, the amount storage means being adapted to store the authentication compensation amount determined on the basis of contents of authentication when performing the authentication.

An authentication system according to the present invention is characterized by comprising the above authentication station and a user terminal connected to the network and having biometrics data acquisition means for causing the user to acquire the biometrics data. In this manner, when the user terminal capable of acquiring the biometrics data is provided on the network, an authentication system capable of performing highly reliable authentication by performing personal authentication can be constructed.

The above authentication system may be characterized in that the user terminal stores a private key corresponding to a public key registered in the digital certificate, the user terminal generates a digital signature using the private key and transmits the digital signature to the authentication station, and the authentication station authenticates the user using the digital signature transmitted from the user terminal. The user can be authenticated as a person who has a private key when the authentication station checks the digital signature.

The user terminal may generate a digital signature in accordance with the private key and biometrics data. When the digital signature is generated using the private key and biometrics data, it is difficult for a third party excluding the authentic user to generate a digital signature, thereby improving the security of the authentication system.

The above authentication system may be characterized in that the user terminal encrypts the biometrics data from the biometrics data acquisition means with the public key of the authentication station and transmits the encrypted biometrics data to the authentication station. When the biometrics data is encrypted as described above, it is difficult to decrypt the biometrics data, thereby improving the security of the authentication system.

The above authentication system may be characterized by comprising the above authentication station, and authentication request means, connected to the network, for requesting the authentication station to authenticate the user. With this arrangement, there can be constructed an authentication system capable of causing the authentication request means to request the authentication station to authenticate the user.

In the above authentication system, preferably, the authentication request means notifies the authentication station of the authentication contents, and the authentication station determines the authentication compensation amount on the basis of the notified authentication contents.

An authentication method of causing an authentication station to authenticate a user connected to a network is characterized by comprising the user registration step of causing the authentication station to issue a digital certificate to the user, storing the digital certificate and validity data representing validity of the digital certificate, acquiring biometrics data as a biological feature of the user from the user, and storing the biometrics data as registration data, the user validity determination step of causing the user to transmit the digital certificate to the authentication station and causing the authentication station to determine the validity of the digital certificate on the basis of the validity data, the biometrics data collation step of causing the user to acquire biometrics data and transmit the biometrics data to the authentication station, and causing the authentication station to collate the biometrics data transmitted from the user with the registration data, and the authentication step of authenticating the user on the basis of a result of the validation determination of the digital certificate and a collation result of the biometrics data.

As described above, according to the authentication method of the present invention, the digital certificate and validity data representing the validity of the digital certificate, and the biometrics data of the user can be used at the time of issuance of the digital certificate stored in the user registration step when the authentication station authenticates the user, i.e., when the user validity determination step and biometrics collation step are performed. In this manner, when the digital certificate and biometrics data are checked, the third party who sets up for the authentic user can be discriminated, thereby performing highly reliable personal authentication.

### BRIEF DESCRIPTION OF THE DRAWINGS

FIG. 1 is a block diagram showing the system configuration of an authentication system according to the first embodiment.

FIG. 2 is a schematic view showing operation of the authentication system according to the first embodiment.

FIG. 3 is a flow chart showing an authentication job in the authentication system according to the first embodiment.

FIG. 4 is a table showing data transmitted as a digital signature request.

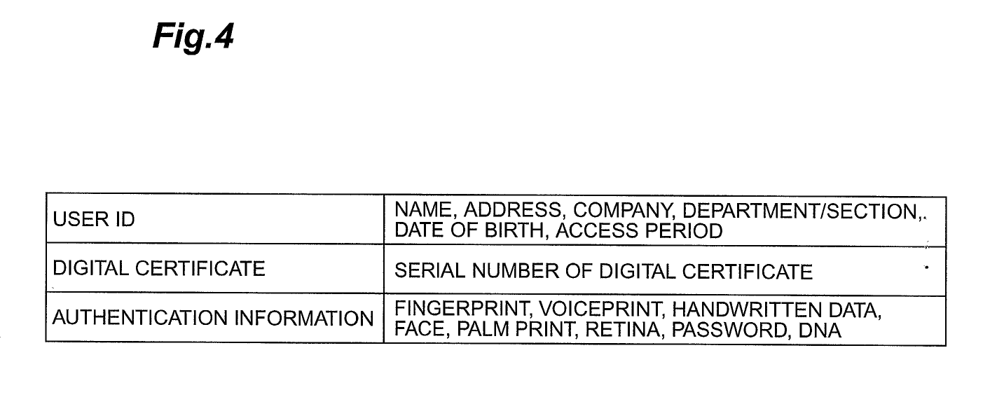

FIG. 5 is a table showing data transmitted as a biometrics data request.

FIG. 6 is a flow chart showing an accounting sequence in the authentication system according to the first embodiment.

FIG. 7 is a table showing data transmitted as accounting attributes.

FIG. 8 is a flow chart showing issuance of a digital certificate in the authentication system according to the first embodiment.

FIG. 9 is a flow chart showing an authentication job in an authentication system according to the second embodiment.

### DESCRIPTION OF THE PREFERRED EMBODIMENTS

Preferred embodiments of an authentication system according to the present invention will be described in detail with reference to the accompanying drawings. The same reference numerals throughout the drawings denote the same parts, and a repetitive description thereof will be omitted.

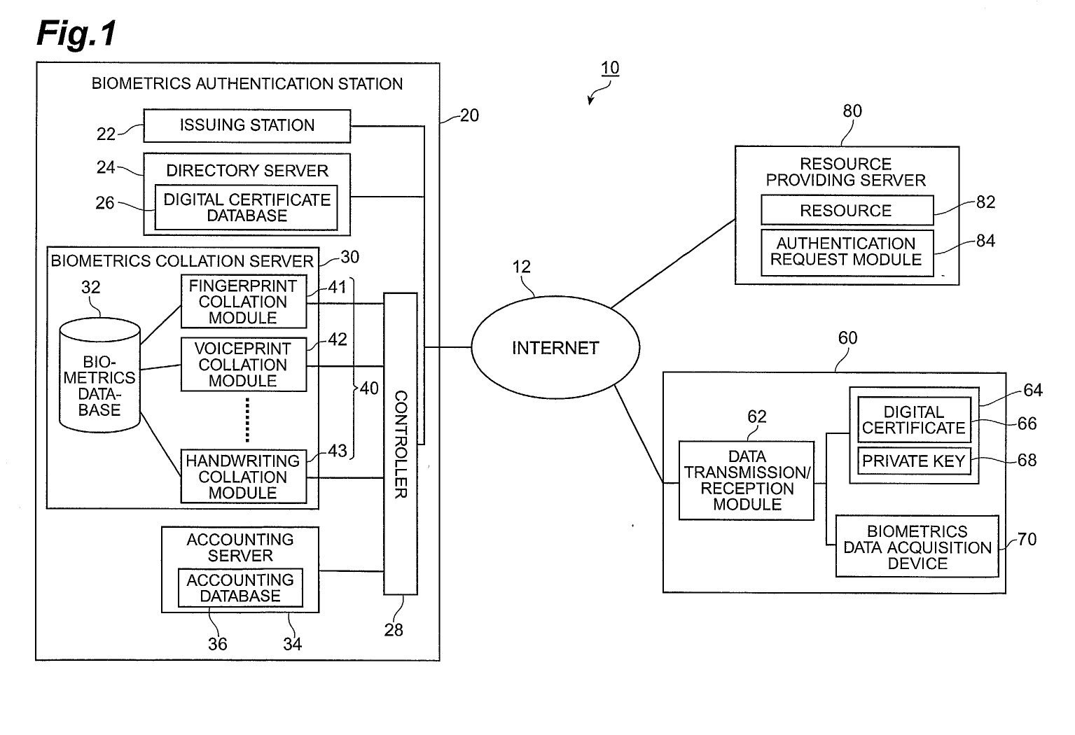

FIG. 1 is a block diagram showing an authentication system 10 according to the first embodiment. In the authentication system 10, a biometrics authentication station 20 for performing authentication and a user terminal 60 used by a user who is to be authenticated are connected to the Internet (network) 12. A resource providing server 80 for providing a predetermined resource 82 is connected to the Internet 12.

The constituent elements will be sequentially described below. First, the biometrics authentication station 20 is comprised of an issuing station 22 for issuing a digital certificate 66, a directory server 24 having a digital certificate database (to be referred to as a “digital certificate DB” hereinafter) 26 serving as a digital certificate storage means, a biometrics collation server 30 for collating the biometrics data, a controller 28 serving as an authentication means for authenticating a user on the basis of validity of a digital certificate and a collation result of the biometrics collation server 30, and an accounting server 34 having an accounting database (to be referred to as an “accounting DB” hereinafter) 36 serving as an amount storage means that stores an authentication compensation amount as accounting information. The biometrics collation server 30 and accounting server 34 are connected to the controller 28.

The biometrics collation server 30 is comprised of a biometrics database (to be referred to as a “biometrics DB” hereinafter) 32 serving as a registration data storage means which stores biometrics data of each user registered in advance, and collation modules 40 for collating the biometrics data stored in the biometrics DB 32 with biometrics data transmitted from the user terminal 60. Each collation module 40 is arranged for a corresponding kind of biometrics data. The collation modules 40 include a fingerprint collation module 41 for collating fingerprint data, a voiceprint collation module 42 for collating voiceprint data, a handwriting collation module 43 for collating handwritten data, and the like. This allows the biometrics collation server 30 to collate a plurality of kinds of biometrics data. The three collation modules 40 are shown in FIG. 1 but they are merely examples. Collation modules for collating biometrics data such as an iris and face may be provided as well.

The digital certificate DB 26 stores a certificate revocation list (to be referred to as a “CRL” hereinafter) as the validation data representing the validity of the digital certificate 66 in addition to the digital certificate 66. The directory server 24 can acquire a CRL in accordance with a request from the controller 28.

The accounting server 34 has the function of storing as accounting information an authentication compensation amount determined by authentication contents every time authentication is performed.

The issuing station 22 has the function of issuing the digital certificate 66 and storing information of the digital certificate 66 issued to the digital certificate DB 26 in the directory server 24.

The user terminal 60 will now be described. In the user terminal 60, a file 64 that stores the digital certificate and a private key 68 and a biometrics data acquisition device 70 for acquiring biometrics data are connected to a data transmission/reception module 62. This allows the user terminal 60 to exchange information including the digital certificate 66 and biometrics data with the biometrics authentication station 20 via the Internet 12.

The resource providing server 80 is comprised of the resource 82 to be provided to users, and an authentication request module 84 serving as an authentication request means for requesting the biometrics authentication station 20 to authenticate a user who accesses the resource 82. The authentication request module 84 has the function of not only requesting the biometrics authentication station 20 to authenticate the user but also notifying the biometrics authentication station 20 of the authentication contents.

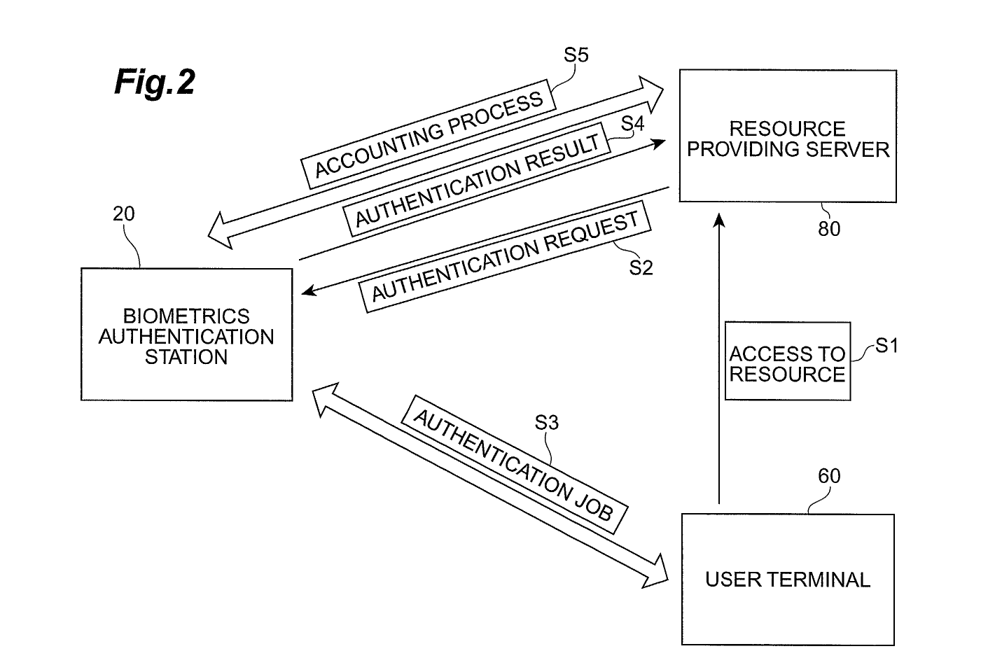

The operation of the authentication system 10 of this embodiment will be described together with the mode of the authentication method of the present invention. First, the outline of the operation of the authentication system 10 will be described with reference to FIG. 2. A user accesses the resource providing server 80 connected to the Internet 12 (see FIG. 1) from the user terminal 60 (S1). To authenticate the user who accessed the resource, the resource providing server 80 operates the authentication request module 84 to transmit an authentication request to the biometrics authentication station 20 (S2). In this case, the resource providing server 80 can set a level associated with authentication reliability. More specifically, when the resource 82 to be provided is highly confidential, the resource providing server 80 can request highly reliable authentication. For example, the resource providing server 80 requests to authenticate the user in accordance with a plurality of biometrics data. An authentication job (S3) is performed between the user terminal 60 and the biometrics authentication station 20 that has received the authentication request. An authentication result is transmitted to the resource providing server 80 (S4). An accounting process for the authentication in the biometrics authentication station 20 is performed between the resource providing server 80 and the biometrics authentication station 20 (S5).

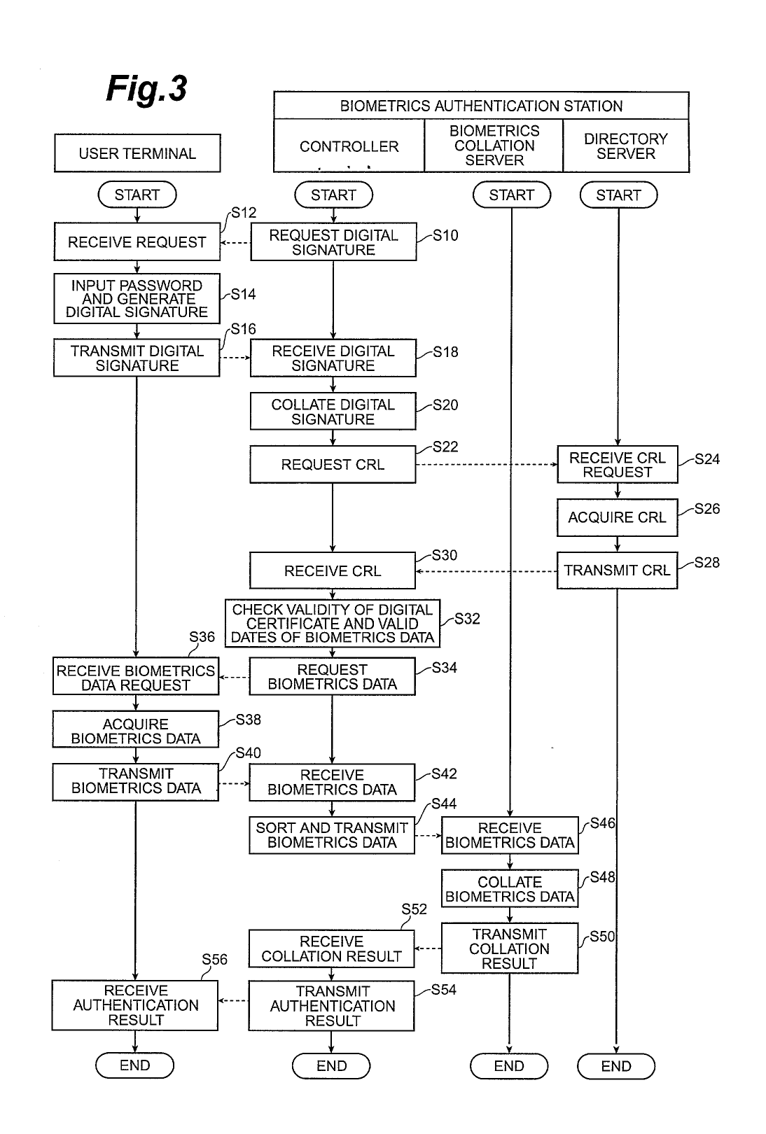

The authentication job (S3) performed between the biometrics authentication station 20 and the user terminal 60 will be described with reference to the flow chart shown in FIG. 3.

In the biometrics authentication station 20, to which the authentically request is sent from the resource providing server 80, the controller 28 requests a digital signature to the user terminal 60 (S10). In this case, data transmitted as the digital signature request includes a user ID as user information such as a name, address, or company, the serial number of the digital certificate 66, and authentication information. The authentication information is information representing the kind of biometrics data registered in the biometrics DB 32. Upon receiving the digital signature request (S12), the user terminal 60 generates a digital signature in response to this request (S14). More specifically, the user inputs a password of the private key 68, encrypts the digital certificate 66 with the private key 68, and generates a digital signature (S14). The user terminal 60 transmits this digital signature and the digital certificate 66 to the biometrics authentication station 20 (S16).

The controller 28 in the biometrics authentication station 20 receives the digital signature transmitted from the user terminal 60 (S18) and collates the digital signatures (S20). More specifically, the controller 28 decrypts the digital signature from the user terminal 60 with the user's public key and compares the decrypted result with the digital certificate 66 transmitted together with the digital signature. If these signatures coincide with each other, it is authenticated that the user of the private key operates the user terminal 60.

The controller 28 transmits a CRL request to the directory server 24 (S22). Upon receiving the CRL request (S24), the directory server 24 acquires the CRL of the corresponding user from the digital certificate DB 26 (S26) and transmits it to the controller 28 (S28).

The controller 28 receives the CRL from the directory server 24 (S30) and determines validity of the digital certificate 66 to check if the digital certificate 66 is invalidated or its valid dates expire (S32). According to this embodiment, information pertaining to the valid dates of biometrics data is stored in the CRL. The controller 28 refers to the CRL to determine whether the valid dates of the biometrics data expire (S32). If NO in step S32, a biometrics data request is transmitted to the user terminal 60 (S34).

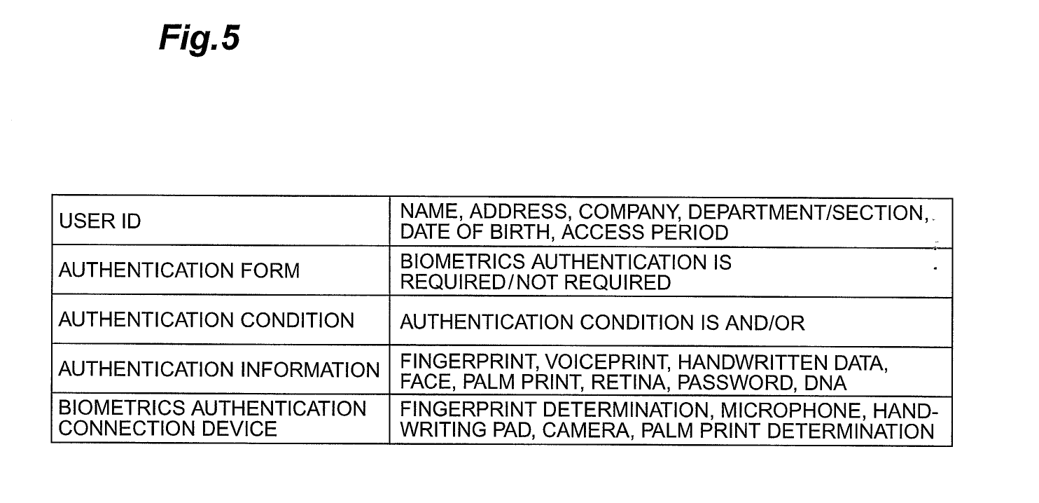

FIG. 5 is a table showing the data transmitted as the biometrics data request. The biometrics data request has various kinds of information such as a user ID serving as user-specific information, an authentication form representing whether biometrics authentication is required, an authentication condition representing a biometrics authentication condition, authentication information representing the type of biometrics authentication, and a biometrics authentication connection device serving as a connection device necessary for authentication. Since the biometrics data request has the authentication form information, the biometrics authentication station 20 need not always authenticate the biometrics data, but can often select an authentication form from which biometrics authentication is omitted. The authentication condition represents a condition for affirmative determination as a result of collation of the biometrics data represented by the authentication information. More specifically, if the authentication condition is an “AND” condition, affirmative determination is allowed only when all biometrics data such as a fingerprint, voiceprint, and handwritten data represented by the authentication information are affirmatively determined. To the contrary, if the authentication condition is an “OR” condition, affirmative determination is allowed, provided that any one of the biometrics data represented by the authentication conditions is affirmatively determined. When the authentication condition is an “AND” condition, the user must input all the biometrics data represented by the authentication information. However, when the authentication condition is an “OR” condition, any one of the biometrics data represented by the authentication information is input. Since the biometrics data request has authentication condition information as described above, the biometrics authentication station 20 can easily set a level pertaining to authentication reliability.

Upon receiving the biometrics data request from the biometrics authentication station 20 (S36), the user terminal 60 prompts the user to input biometrics data represented by the authentication information of the biometrics data request. The user terminal 60 then acquires user's biometrics data using the biometrics data acquisition device 70 (S38). The user terminal 60 then transmits the acquired biometrics data to the controller 28 (S40).

Upon receiving the biometrics data from the user terminal 60 (S42), the controller 28 transmits the biometrics data to the collation modules 40 capable of collating the biometrics data on the basis of the type of received biometrics data (S44). Upon receiving the biometrics data from the controller 28 (S46), the collation modules 40 of the biometrics collation server 30 search the biometrics DB 32 for the biometrics data of the corresponding user. The collation modules 40 collate the searched biometrics data with the received biometrics data (S48) and send the collation results to the controller 28 (S50).

Upon receiving the collation results from the biometrics collation server 30 (S52), the controller 28 transmits an authentication result to the user terminal 60 on the basis of the validity of the digital certificate 66 and the collation results of the biometrics data (S54). Upon receiving the authentication result from the biometrics authentication station 20 (S56), the user terminal 60 completes the authentication job (S3). As shown in FIG. 2, the biometrics authentication station 20 also transmits the authentication result to the resource providing server 80 (S4).

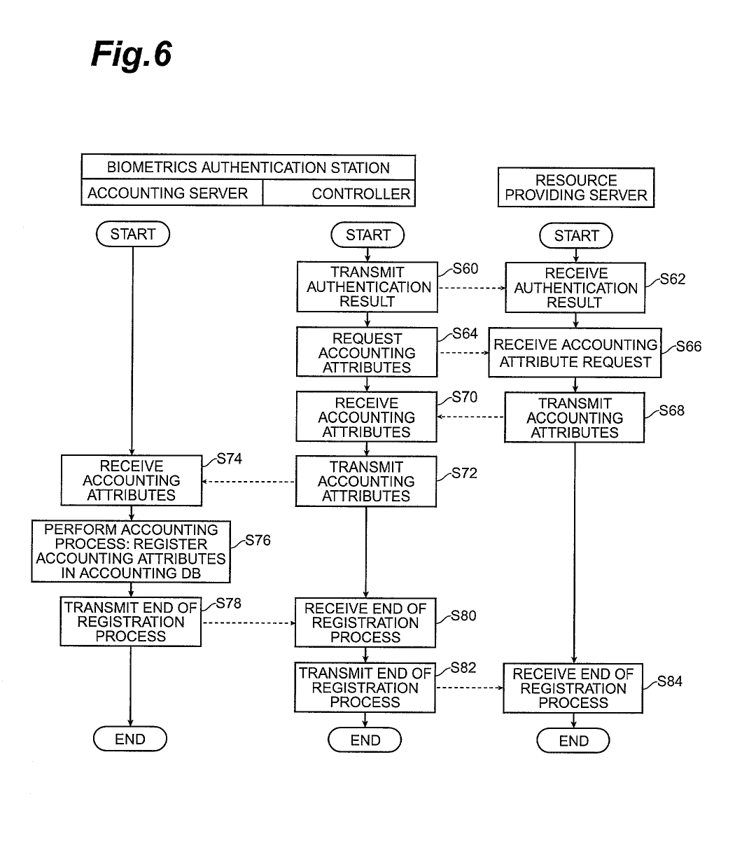

An accounting process (S5) performed between the biometrics authentication station 20 and the resource providing server 80 next to the authentication job (S3) will be described with reference to the flow chart in FIG. 6. When the authentication job (S3) is complete, the authentication result is transmitted from the biometrics authentication station 20 to the resource providing server 80 (S4) as described above. That is, the controller 28 in the biometrics authentication station 20 transmits the authentication result to the resource providing server 80 (S60), and the resource providing server 80 receives this (S62).

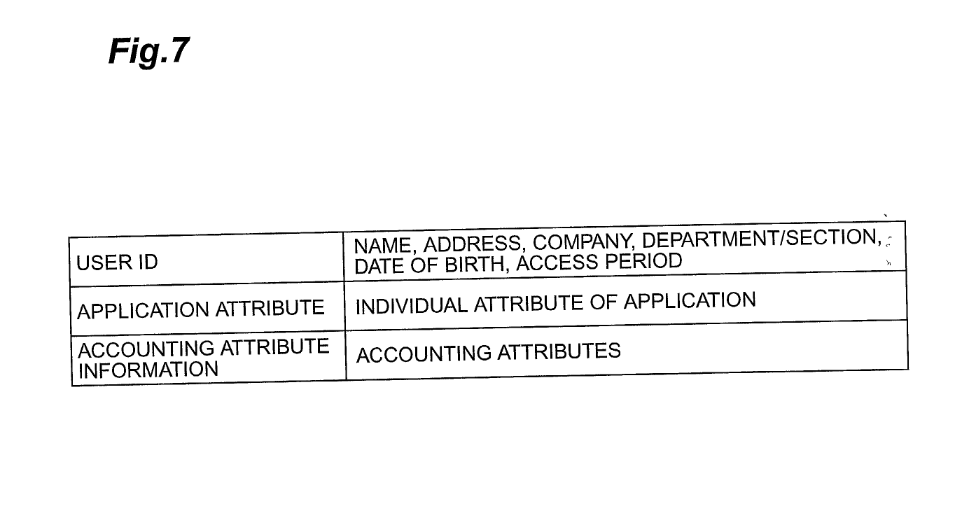

Next to transmission (S4) of the authentication result, the biometrics authentication server 20 transmits to the resource providing server 80 an accounting attribute request for inquiring the presence/absence of accounting and an accounting amount (S64). Upon receiving the accounting attribute request from the biometrics authentication station 20 (S66), the resource providing server 80 operates the authentication request module 84 to transmit to the biometrics authentication station 20 accounting attributes determined on the basis of the resource 82 or the like provided to the authenticated user (S68). In this case, data transmitted as the accounting attributes from the resource providing server 80 to the biometrics authentication station 20 has a user ID, application attribute, and accounting attribute information, as shown in FIG. 7.

The application attribute is an individual attribute of an application provided. The application attribute is managed as a log to allow specifying an application serving as an accounting target. The accounting attribute information is information pertaining to accounting. A concrete example will be described for the relationship between the accounting attribute information and the resource 82 provided. Assume that the resource 82 provided by the resource providing server 80 is an inquiry for an outstanding balance, a transfer procedure, and the like in Internet banking. For example, when a service provided to a user is a transfer of ¥1,000,000 or less, accounting attribute information represents “without accounting”. For a transfer of ¥1,000,000 or more, accounting attribute information represents “with accounting”. In this manner, the accounting attribute is transmitted to the biometrics authentication station 20. The biometrics authentication station 20 sends an accounting request to the resource providing server 80 on the basis of this accounting attribute information to allow the biometrics authentication station 20 to assure authentication reliability within a predetermined range, thereby improving reliability of the authentication system 10. Note that the accounting attribute information is not limited to “with accounting” and “without accounting”, but may be information representing that the accounting amounts change stepwise in accordance with the types of resources 82 provided by the resource providing server 80.

Upon receiving the accounting attributes from the resource providing server 80 (S70), the controller 28 in the biometrics authentication station 20 transmits the received accounting attributes to the accounting server 34 (S72). Upon receiving the accounting attributes from the controller 28 (S74), the accounting server 34 registers the received accounting attributes in the accounting DB 36 (S76). The accounting server 34 transmits the end of registration process to the controller 28 (S78), and the controller receives the end of registration process from the accounting server 34 (S80). Subsequently, the controller 28 transmits the end of registration process to the resource providing server 80 (S82), the resource providing server 80 receives this (S84), and the accounting process (S5) is complete.

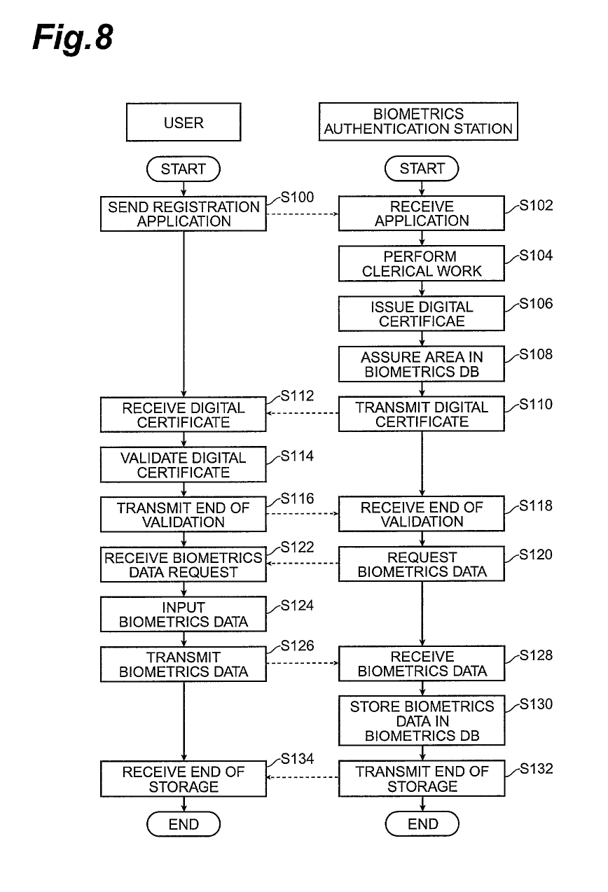

The issuance of the digital certificate 66 by the issuing station 22 and the corresponding operation of the biometrics authentication station 20 will be described with reference to the flow chart in FIG. 8.

The user sends a registration application to the biometrics authentication station 20 (S100). The biometrics authentication station 20 receives this application (S102) and performs clerical work such as personal reference of the user and data input to the PC (S104). When the clerical work is complete, the issuing station 22 issues the digital certificate 66 for this user (S106) and stores this digital certificate 66 in the digital certificate DB 26. In this case, the issuing station 22 also stores the valid dates of the biometrics data in the digital certificate DB 26. The biometrics authentication station 20 assures an area for storing biometrics data for authenticating the user in the biometrics DB 32 (S108). The biometrics authentication station 20 transmits the issued digital certificate 66 to the user (S110), and the user receives the digital certificate 66 (S112). The user then inputs a tentative ID separately mailed from the biometrics authentication station 20 to validate the received digital certificate 66 (S114). The user transmits an end of validation of the digital certificate 66 to the biometrics authentication station 20 (S116).

Upon receiving a notification representing the end of validation of the digital certificate 66 (S118), the biometrics authentication station 20 sets it in the digital certificate DB 26 and requests the user to send biometrics data (S120). Upon receiving the biometrics data request from the biometrics authentication station 20 (S122), the user inputs the biometrics data at the user terminal 60 (S124). The user transmits the biometrics data input at the user terminal 60 to the biometrics authentication station 20 (S126). The biometrics authentication station 20 receives the biometrics data from the user (S128), stores the received biometrics data in the biometrics DB 32 (S130), and transmits the end of storage to the user (S132). The user receives the end of storage from the biometrics authentication station 20 (S134), and issuance of the digital certificate 66 is complete.

The effect of the biometrics authentication station 20 and authentication system 10 of this embodiment and the authentication method using them will be described below.

The biometrics authentication station 20 of this embodiment has the digital certificate 66 and the digital certificate DB 26 for storing it, and the biometrics DB 32 for storing biometrics data. The biometrics authentication station 20 determines validity of the digital certificate 66 and collates the biometrics data input from the user terminal 60 to perform personal authentication of the user. Authentication reliability can therefore be improved.

In the biometrics authentication station 20 of this embodiment, the digital certificate DB 26 stores the validity data of the digital certificate 66 and the valid dates of the biometrics data. The biometrics authentication station 20 can check the valid dates of the biometrics data and can register new biometrics data before the old biometrics data changes over time not to allow collation.

In addition, the biometrics authentication station 20 of this embodiment also includes the issuing station 22 for issuing the digital certificate 66. Information pertaining to the biometrics data can be stored in the digital certificate DB 26 at the time of issuance of the digital certificate 66. The digital certificate and the biometrics data can be managed altogether.

The authentication system 10 having the above biometrics authentication station 20 of this embodiment, and the authentication method using the authentication system 10 can perform personal authentication of the user connected to the Internet 12 to allow improving authentication reliability.

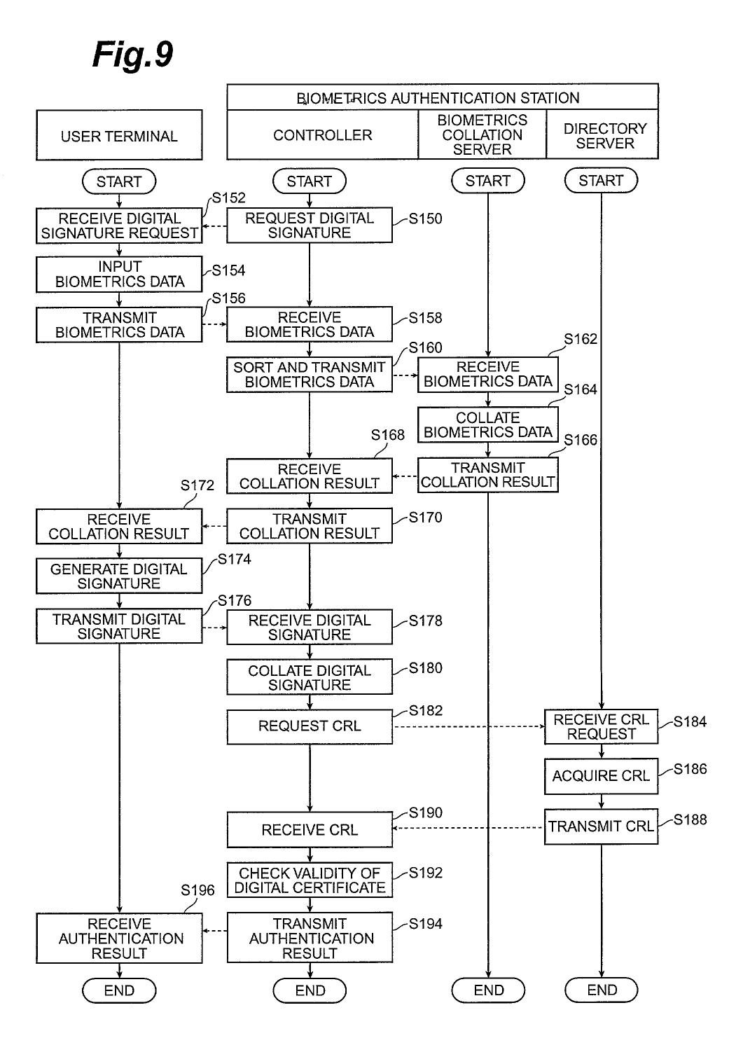

The second embodiment of the present invention will be described below. An authentication system of the second embodiment basically has the same system configuration as that of the authentication system 10 of the first embodiment, except that operation in the authentication job between the biometrics authentication station 20 and the user terminal 60 is different from that of the first embodiment. More specifically, the authentication system of the second embodiment is different from that of the first embodiment in that biometrics data is used as a password for a private key 68. The authentication job of the authentication system of the second embodiment will be described with reference to the flow chart in FIG. 9.

A controller 28 of the biometrics authentication station 20 transmits a digital signature request to the user terminal 60 (S150). Upon receiving the digital signature request from the biometrics authentication station 20 (S152), the user terminal 60 prompts the user to input the password of the private key 68 for generating a digital signature, i.e., biometrics data in this embodiment. The user inputs the biometrics data (S154). The user terminal 60 transmits the input biometrics data to the biometrics authentication station 20 to check if the input biometrics data is valid (S156). The controller 28 in the biometrics authentication station 20 receives the biometrics data from the user terminal 60 (S158) and transmits the received biometrics data to a biometrics collation server 30 (S160). The biometrics collation server 30 receives the biometrics data from the controller 28 (S162), collates the received biometrics data (S164), and transmits a collation result to the controller 28 (S166).

Upon receiving the collation result from the biometrics collation server 30 (S168), the controller 28 transmits the collation result to the user terminal 60 (S170). The user terminal 60 receives the collation result from the biometrics authentication station 20 (S172). If the collation result is OK, the private key 68 operates to generate a digital signature (S174). The user terminal 60 transmits the generated digital signature to the controller 28 (S176). The controller 28 receives the digital signature from the user terminal 60 (S178), collates the received digital signature (S180), and requests a CRL to a directory server 24 (S182). Upon receiving the CRL request from the controller 28 (S184), the directory server 24 acquires the corresponding CRL from a digital certificate DB 26 (S186), and transmits it to the controller 28 (S188). The controller 28 receives the CRL from the directory server (S190), determines the validity of a digital certificate 66 on the basis of the CRL (S192), and transmits this result as the authentication result to the user terminal 60 (S194). The user terminal 60 receives the authentication result from the biometrics authentication station 20 (S196) to complete the authentication job.

The authentication system of the second embodiment can improve authentication reliability as in the authentication system 10 of the first embodiment and additionally has the following effects. More specifically, in the authentication system of the second embodiment, since the biometrics data is used in place of the password for the private key 68, a third party except the authentic user cannot generate a digital signature using the private key, thereby improving security of the authentication system. The user need not input both the biometrics data and the password, the user need not keep memorizing the password or need not worry about robbery of the password.

The embodiments of the present invention have been described above. The present invention is not limited to these particular embodiments.

In each of the embodiments described above, a resource providing terminal 80 for providing a predetermined resource 82 on the Internet 12 is exemplified, and a biometrics authentication station 20 performs authentication in response to a request from the resource providing server 80. An authentication system according to the present invention is not limited to this. For example, the present invention is also applicable to a case wherein an Internet provider authenticates a user who logs on to the Internet.

In each of the embodiments described above, biometrics data may be encrypted using a public key provided by the biometrics authentication station 20, and this encrypted data may be transmitted. The possibility of tapping or decrypting biometrics data can be reduced, and security of the authentication system can be improved.

According to the present invention, an authentication station comprises a digital certificate, a digital certificate storage means for storing the digital certificate, and a registration data storage means for storing biometrics data. Therefore the authentication station can check the validity of the digital certificate and collates biometrics data transmitted from a user with the registered biometrics data. The authentication station can perform personal authentication of a user connected to a network, thereby improving authentication reliability.

The digital certificate storage means stores the valid dates of the biometrics data. An inconvenience in which an authentic user cannot be collated due to changes over time of the biometrics data can be prevented by updating the old biometrics data.

The authentication station of this embodiment has an issuing station for issuing a digital certificate. The digital certificate and biometrics data can be managed altogether from the time of issuance of the digital certificate.

The authentication station has an amount storage means and can manage a value accrued in authentication.

The authentication system, the authentication method using the above authentication station according to the present invention have the above authentication station and can perform personal authentication of a user connected to a network, thereby improving authentication reliability.

What is claimed is:

1. An authentication station for authenticating a user connected to a network, characterized by comprising:
digital certificate storage means for storing a digital certificate issued to the user and validity data representing validity of the digital certificate;
registration data storage means for storing as registration data biometrics data based on a biological feature of the user;
a collation server for collating biometrics data transmitted from the user with the registration data stored in said registration data storage means; and
authentication means for determining the validity of the digital certificate of the user, for which authentication is demanded, on the basis of the validity data stored in said digital certificate storage means, and authenticating the user on the basis of a result of the validity determination and a collation result of said collation server.

2. An authentication station according to claim 1, characterized in that said collating means collates a plurality of kinds of biometrics data.

3. An authentication station according to claim 1, characterized in that
said digital certificate storage means stores valid dates of the registration data stored in said registration data storage means, and
said authentication means determines the validity of the biometrics data of the user, for which authentication is demanded, on the basis of the valid dates stored in said digital certificate storage means.

4. An authentication station according to claim 3, characterized by further comprising an issuing station for issuing the digital certificate, said issuing station being adapted to store the valid dates of the biometrics data in said digital certificate storage means when issuing the digital certificate.

5. An authentication station according to claim 1, characterized by further comprising amount storage means for storing an authentication compensation amount, said amount storage means being adapted to store the authentication compensation amount determined on the basis of contents of authentication when performing the authentication.

6. An authentication system characterized by comprising:
said authentication station defined in claim 1; and
a user terminal connected to said network and having biometrics data acquisition means for causing the user to acquire the biometrics data.

7. An authentication system according to claim 6, characterized in that
said user terminal stores a private key corresponding to a public key registered in the digital certificate,
said user terminal generates a digital signature using the private key and transmits the digital signature to said authentication station, and
said authentication station authenticates the user using the digital signature transmitted from said user terminal.

8. An authentication system according to claim 6, characterized in that
said user terminal stores a private key corresponding to a public key registered in the digital certificate,
said user terminal generates a digital signature in accordance with the private key and the biometrics data and transmits the digital signature to said authentication station, and
said authentication station authenticates the user in accordance with the digital signature transmitted from said user terminal.

9. An authentication system according to claim 7, characterized in that said user terminal encrypts the biometrics data from said biometrics data acquisition means with the public key of said authentication station and transmits the encrypted biometrics data to said authentication station.

10. An authentication system characterized by comprising:
said authentication station defined in claim 1; and
authentication request means, connected to said network, for requesting said authentication station to authenticate the user.

11. An authentication system characterized by comprising:
said authentication station defined in claim 5; and
authentication request means, connected to said network, for requesting said authentication station to authenticate the user and notifying said authentication station of authentication contents,
wherein said authentication station determines the authentication compensation amount on the basis of the notified authentication contents.

12. An authentication method of causing an authentication station to authenticate a user connected to a network, characterized by comprising:
the user registration step of causing the authentication station to issue a digital certificate to the user, storing the digital certificate and validity data representing validity of the digital certificate, acquiring biometrics data as a biological feature of the user from the user, and storing the biometrics data as registration data;
the user validity determination step of causing the user to transmit the digital certificate to the authentication station and causing the authentication station to determine the validity of the digital certificate on the basis of the validity data;
the biometrics data collation step of causing the user to acquire biometrics data and transmit the biometrics data to the authentication station, and causing the authentication station to collate the biometrics data transmitted from the user with the registration data; and
the authentication step of authenticating the user on the basis of a result of the validation determination of the digital certificate and a collation result of the biometrics data.

13. An authentication method according to claim 12, characterized in that
the user registration step comprises acquiring a plurality of kinds of biometrics data from the user and storing the biometrics data as registration data, and
the biometrics data collation step comprises collating the registration data with each of the plurality of kinds of biometrics data transmitted from the user.

14. An authentication method according to claim 12, characterized in that
the user registration step further comprises storing valid dates of the registration data, and
the biometrics data collation step further comprises causing the authentication station to determine validity of the biometric data from the user on the basis of the valid dates.

15. An authentication method according to claim 12, characterized by further comprising the authentication compensation storage step of storing an authentication compensation amount determined on the basis of the authentication contents when the authentication station authenticates the user.

16. An authentication method according to claim 12, characterized in that the user validity determination step comprises causing the user to generate a digital signature by a private key corresponding to a public key registered in the digital certificate and transmit the digital signature, and causing the authentication station to authenticate the user in accordance with the digital signature transmitted from the user.

17. An authentication method according to claim 12, characterized in that the user validity determination step further comprises causing the user to generate a digital signature by biometric data and a private key corresponding to a public key registered in the digital certificate and transmit the digital signature, and causing the authentication station to authenticate the user in accordance with the digital signature transmitted from the user.

18. An authentication method according to claim 12, characterized in that the biometrics data collation step comprises causing the user to encrypt biometrics data with the public key of the authentication station and transmits the encrypted biometrics data to the authentication station.

19. An authentication method according to claim 12, characterized by further comprising the authentication request step of causing a resource provider who provides a predetermined resource on the network to request the authentication station to authenticate the user.

20. An authentication method according to claim 15, characterized by further comprising the authentication request step of causing a resource provider who provides a predetermined resource on the network to request the authentication station to authenticate the user and notify the authentication station of authentication contents,
the authentication compensation storage step being adapted to comprise determining the authentication compensation amount on the basis of the notified authentication contents.
